(19) United States
(12) Patent Application Publication
(10) Pub. No.: US 2022/0353561 A1
(43) Pub. Date: Nov. 3, 2022

(54) LIVE PERFORMANCE, ENGAGEMENT, AND SOCIAL MEDIA PLATFORM

(71) Applicant: Imperial Views LLC, Duluth, GA (US)

(72) Inventor: Nasi Gaddy, McDonough, GA (US)

(21) Appl. No.: 17/733,822

(22) Filed: Apr. 29, 2022

Related U.S. Application Data
(60) Provisional application No. 63/181,263, filed on Apr. 29, 2021.

(51) Int. Cl. H04N 21/258; H04N 21/234; G06F 16/78; G06Q 50/00

(52) U.S. Cl. CPC H04N 21/25816; H04N 21/23424; G06F 16/78; G06Q 50/01

(57) ABSTRACT

In one aspect, the present disclosure relates to a live streaming performance platform comprising: a main central screen showing a main act; surrounded by scrollable smaller screens containing live feeds of other acts; and audience cams, feeds from other computers, mobile devices, or televisions, wherein the scrollable smaller screens can be accessed and interjected onto the main screen as or with the main act, wherein a user can interact with the main screen, and wherein a user can independently view and interact with other audience members. The platform may authenticate a user, The platform may further receive content from the authenticated user and metadata associated with the content. The platform may organize the content based on the received metadata to form an organized content feed, and transmit the organized content feed to one or more users for display.

### RELATED APPLICATION

This application claims benefit under the provisions of 35 U.S.C. § 119(e) of U.S. Provisional Application No. 63/181,263 filed on Apr. 29, 2021, which is incorporated herein by reference in its entirety.

It is intended that the above-referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to live streaming, networking, social media, and broadcasting.

### BACKGROUND

Current state-of-the-art in live streaming only allows a few people on the platform at a time, and while multiple people are on a platform a viewer must generally rely on the discretion of the people being viewed to communicate effectively with them and then only one at the time. This is generally the only way the public can understand what is being spoken about on the video platform. Furthermore, the public cannot communicate to those on the platform effectively.

Further, Current social media platforms are deficient in not necessarily allowing the general public to meet people from all over the world and to network and communicate visually and/or through text. This is particularly important in an era of social distancing and when quarantine rules and regulations are in effect.

Accordingly, new social media platforms that can allow individuals to network and conduct business in response to current realities are needed.

Further, there is a need for better live performance streaming applications, particularly for those who are homebound or quarantined.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, the present disclosure relates to a platform comprising: a geographic selection feature enabling a user to select a specific geographic region from a map; a feature providing how many other users are active in that geographic region; optionally viewing and archiving video footage and photos of current community members that are open to the public in the geographic region; a feature allowing user to view profiles of other users that are streaming live in the geographic region; a feature of user going live and starting a private room, or browsing other profiles and rooms open to the public, and an in-app currency to be used within the platform.

In another aspect, the present disclosure relates to a live streaming performance platform comprising: a main central screen showing a main act; surrounded by scrollable smaller screens containing live feeds of other acts; and audience cams, feeds from other computers, mobile devices, or televisions, wherein the scrollable smaller screens can be accessed and interjected onto the main screen as or with the main act, wherein a user can interact with the main screen, and wherein a user can independently view and interact with other audience members.

In another aspect, the present disclosure relates to a platform comprising a plurality of user tiers comprising: a 1st Tier User: Main (Central) Screen, Performing main act; a 2nd Tier User: Each 2nd tier user Located on a Plurality of Peripheral Screens surrounding the 1st tier user, Screens provide live feeds of the 2nd user (can display whatever the 2nd tier user wants—other acts, audience cams, feeds mobile devices, etc..), 2nd tier user may view/interact with any other user (1st Tier, 2nd Tier, 3rd Tier), Each user may invite a Third Tier user to be a Second Tier User; and a 3rd Tier User: Can view live feeds.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non- limiting, explanatory purposes of certain embodiments detailed in the present disclosure. In the drawings:

FIG. 1 illustrates a video performance platform for performing the methods and functions of the application;

FIG. 2 illustrates an opening screen for user interaction with the platform;

FIG. 3 illustrates active users and cams in a selected area on the platform;

FIG. 4 Illustrates a public party room including all live feeds;

FIG. 5 Illustrates a private party room with a host on the platform;

FIG. 6 illustrates a flowchart of a method of operation of the platform;

FIG. 7 illustrates a flowchart of a method of promotion of a user; and

FIG. 8 is a block diagram of a system including a computing device for performing the methods and functions of the platform.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of live streaming, networking, social media, and broadcasting, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure provides a platform that may enable people to connect from all over the world on a social and business networking platform. The platform may integrate a collage of technologies with a new on-line arena and filming studio process. The disclosed social media application represents a new way for people to interact across the globe using new ways of communicating.

In the disclosed platform, upon logging in, a digitized view of a map or globe may be presented to a user (e.g., on the user's computer or mobile device). The user may be greeted verbally (virtually) and/or may be shown how many of the user's friends are currently online and active. In embodiments, the application may show how many cameras (e.g., video cams) are open to the public, and/or how many cameras are active in a surrounding geographic area in total. Viewing features may vary depending on a user's device. Users may have access to any parts of the globe which the user chooses. In embodiments, the default access may be a geographic area that includes the user's actual geolocation. Viewing features may be accessed through touch, talk, and/or text.

The platform may include a video streaming platform including a collage of different technologies, wherein the video streaming platform of the disclosure integrates multiple technologies.

The present disclosure may provide users with access to an online arena venue/filming studio. The disclosed arena/film studio may be controlled from any location. That is, a control center may be set up anywhere and may handle up to millions of viewers from around the world. In embodiments, the disclosed video streaming platform may provide viewers a forum for interacting with one another textually and/or visually.

The video screen of a viewer may be laid out such that a main act or host is displayed on a main screen centered in the middle of the screen, and/or provided with the largest display area. Live feeds of other users may be interjected into the main screen from smaller screens that border the main screen. That is, live feeds that border the main screen can be interjected onto the main screen. Live feeds may also be interjected onto the main screen based on input from a control room (e.g., at the control room's discretion).

Another feature of the disclosed video streaming platform is enabling the audience to send messages (e.g., text messages, emoji, and/or the like) for display on the main screen. The audience may also send, to one another, messages (e.g., emojis, representations of champagne, popcorn, etc.). As a particular example, in a comedy show embodiment, the audience may be able to interact with the host or main act (e.g., a comedian) by liking or disliking jokes told by the comedian. The jokes may be rated by percentile and/or absolute like and/or dislike numbers on the side of the screen after each joke for audience viewing. For example, there could be an indication that, 60% of the audience liked a particular joke, and 40% disliked the joke.

The disclosed video streaming platform may provide the audience with the ability to “surf the crowd” in an audience viewing mode. For example, an audience member may navigate to a screen that will present audience video cams that are open to the public. Each audience camera may have the option to be open to friends, to the public, or be private. If in private mode, viewers will be able to send a request via text to open visual communication. If open visual communication is established, the main screen can be split in half with the established visual communication now on the main screen and a smaller screen still showing a miniature version of the main act. Options will include still listening to the performance on the main screen or choosing not to listen to the performance on the main screen and communicating strictly with the audience member or members that they established visual communication with.

Besides the control booth, the other way to interject live feed to the main screen will be at sub control booths from where an artist is located. When in audience viewing mode or crowd surf mode, the screen may become one screen of multiple live feeds where a user can scroll up or down and interact with other audience members at their discretion.

In addition, audience profile pictures may be next to a member's comments, so if an audience member sees a comment from an individual that they know, the audience member may click on the individual's profile picture and access a live feed from the individual. In embodiments, live feeds may be arranged around a border of the main act screen and may be called VIP booths. Arranging live feeds around the main act screen may enable one or more special guests who are valued customers to choose to pay a VIP rate for a VIP booth, so that other members of the audience are able to view the live feed of the one or more special guest.

The disclosed video performance platform solves the problem of people not being able to gather. Thus, people will be able to network on business, discuss current problems, and be able to attend social Internet events with the disclosed system. Embodiments of the present disclosure may comprise methods, systems, and a computer readable medium comprising, but not limited to, at least one of the following:

A. A UI Layer;

B. A Relay Layer;

C. An API Layer;

D. A Protocol Layer;

In some embodiments, the present disclosure may provide an additional set of modules for further facilitating the software and hardware platform. The additional set of modules may comprise, but not be limited to:

E. An Oracle Layer; and

F. A Decentralized Exchange Layer.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 800 may be employed in the performance of some or all of the stages disclosed with regard to the methods. Similarly, an apparatus may be employed in the performance of some or all of the stages of the methods. As such, the apparatus may comprise at least those architectural components as found in computing device 800.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Although the aforementioned method has been described to be performed by the platform 100, it should be understood that computing device 800 may be used to perform the various stages of the method. Furthermore, in some embodiments, different operations may be performed by different networked elements in operative communication with computing device 800. For example, a plurality of computing devices may be employed in the performance of some or all of the stages in the aforementioned method. Moreover, a plurality of computing devices may be configured much like a single computing device 800. Similarly, an apparatus may be employed in the performance of some or all stages in the method. The apparatus may also be configured much like computing device 800.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

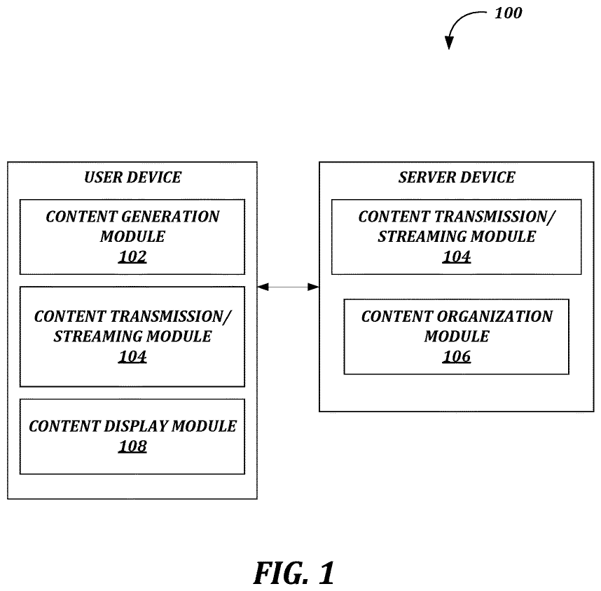

FIG. 1 illustrates one possible operating environment through which a platform consistent with embodiments of the present disclosure may be provided. By way of non-limiting example, a live performance, engagement, and social media platform 100 may be hosted on, for example, a cloud computing service. In some embodiments, the platform 100 may be hosted on a computing device 800. A user may access platform 100 through a software application and/or hardware device. The software application may be embodied as, for example, but not be limited to, a website, a web application, a desktop application, and a mobile application compatible with the computing device 800. One possible embodiment of the software application and/or hardware device may be provided by the VVUES™

suite of products and services provided by Imperial Views LLC.

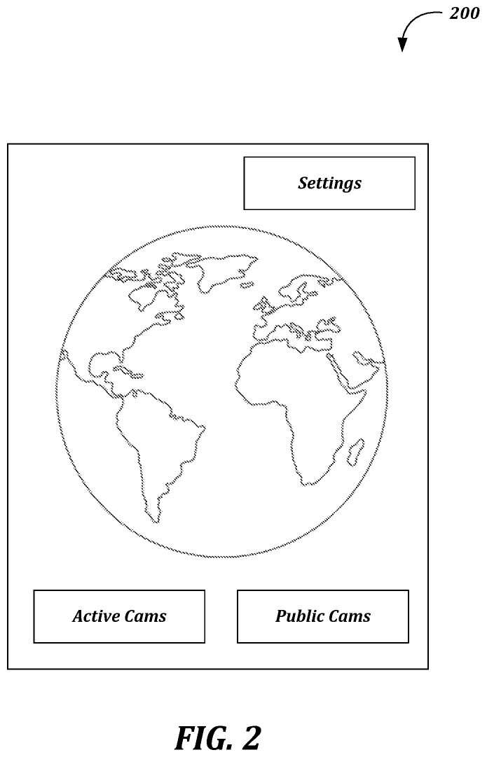

FIG. 2 illustrates an opening screen 200. The opening screen 200 may include an indication of how many active cams (e.g., active video feeds), public cams (e.g., public video feeds), and/or other users are active and available. In some embodiments, the opening screen 100 includes an options tab providing user preference features.

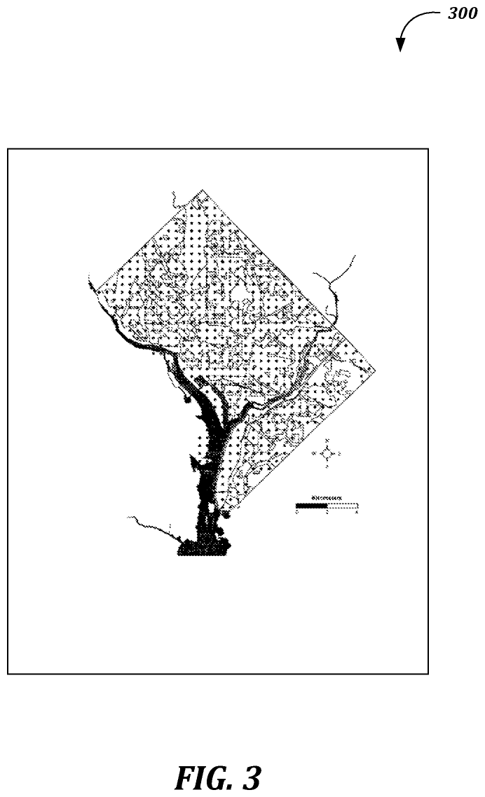

FIG. 3 illustrates a screen 300 showing a map of active cams and/or active users in particular geographic area. The particular area may be, for example, the world, a country, a state, a region, a city, a neighborhood, or any other geographically defined area. That is, while the example shown in FIG. 3 shows active cams and users in Washington, DC, those of skill in the art will recognize that different geographical regions or areas may be shown without departing from the scope of the invention. FIG. 3 shows active users and cams in the selected area. The disclosed social media application provides zoom options for the selected region. When a user zooms in on a particular portion of the geographic area, the application may display only active cams and/or active users located within the particular portion of the geographic area.

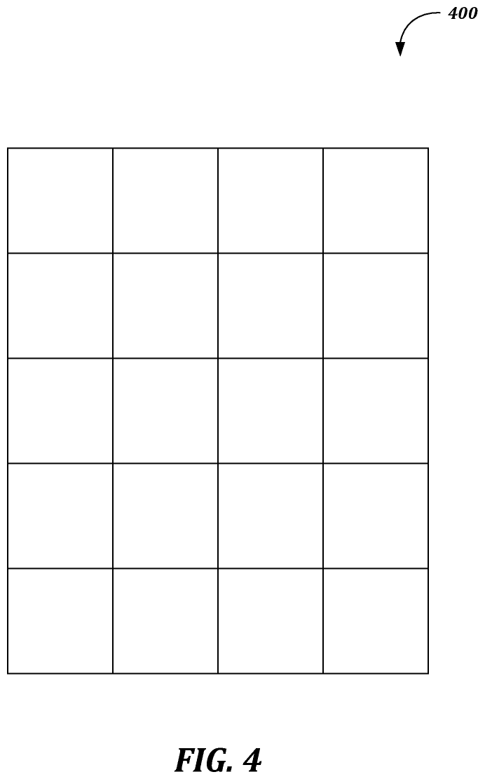

FIG. 4 illustrates a screen 400 showing a public party room. In embodiments, the public party room may include a plurality of live video and/or audio feeds. In some embodiments, the public party room may include a video and/or audio feed associated with one or more (e.g., each) user that has entered into the public party room. A user that enters the public party room may view one or more of the video and/or audio feeds by scrolling through the available feeds and/or zooming in on one or more of the available feeds. In embodiments, the public party room may include a text-based chatroom allowing the guests that entered into the public party room to interact via text inputs. A user may have the option of entering a party room when the user is granted permission to do so. Alternatively or additionally, the user may starting their own public party room.

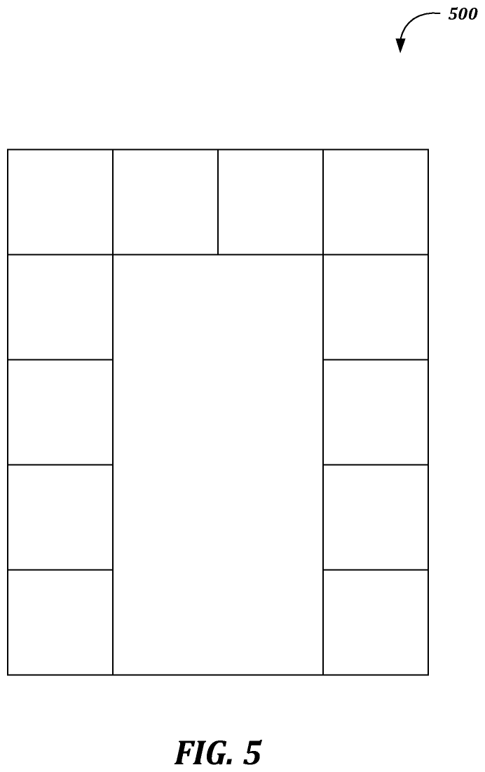

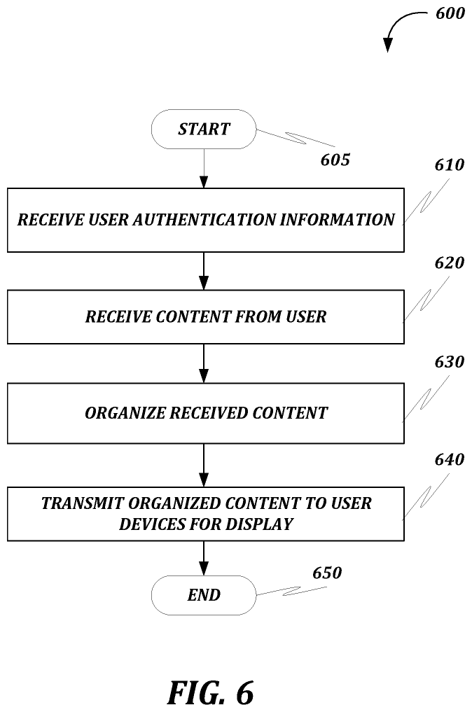

FIG. 5 illustrates a screen 500 showing a private party room. In embodiments, each private party room may be associated with a host. The host associated with the private party room may allow a particular number of selected users (e.g., 4 selected users) to participate in a main screen of the private party. For example, participating in the main screen may include displaying a video and/or audio feed from the host and/or the selected users in the area designated as the main screen. In embodiments, the main screen may surrounded by smaller screens, which may display live video and/or audio feeds from other users and/or cameras associated with the private party room. For example, FIG. 6 illustrates a private party room 600 having a

Accordingly, embodiments of the present disclosure provide a software and hardware platform comprised of a distributed set of computing elements, including, but not limited to:

A. Content Generation Module

A content generation module 102 may include hardware and/or software configured to generate content for display in other portions of the platform 100. For example, the content generation module 102 may be configured to gather video and/or audio data from a camera and/or microphone associated with a user. In embodiments, the camera and/or microphone may include a camera and/or microphone integrated into a computing device, such as a laptop or desktop computer, a tablet computer, a smartphone, or other smart device, and/or the like. There are many devices capable of content generation using a camera and/or microphone.

In some embodiments, the content generation module 102 may further comprise an interface for allowing a user to generate textual content. For example, the content generation module may include a keyboard, a soft keyboard, a speech to text interface, and/or the like.

In embodiments, the content generation module 102 may be embodied on (e.g., operate on, stored on, or interfaced with) a user device, such as a laptop or desktop computer, a tablet computer, a smartphone, or other smart device, and/or any other computing device operated by a platform user.

B. Content Transmission/Streaming Module

A content transmission/streaming module 104 may include hardware and/or software configured to transmit content created by a user (e.g., using the content generation module 102) to the platform 100 for processing. For example, the content transmission/streaming module 104 may be configured to transmit content to the platform using one or more wired and/or wireless data communication methods, including wired data transmission methods IEEE 802.3 standards, wireless transmission methods compliant with IEEE 802.11 Local Area Network standards (e.g., Wi-Fi communication), cellular communication (e.g., 5G, LTE, EDGE, GPRS, and/or the like), transmission methods compliant with IEEE 802.15 Personal Area Network standards, and/or other similar wired or wireless communication methods.

In some embodiments, the content transmission/streaming module may be used to transmit or stream the content from a user device to a server computer, such as a centralized server, a cloud-based server, or any other server computer. In some embodiments, the content transmission/streaming module may be used to transmit or stream the content from a server computer to a user device.

C. Content Organization Module

A content organization module 106 may include hardware and/or software configured to organize content. In some embodiments, the content may be organized based on metadata associated with the content. For example, the metadata may include a geolocation associated with the device used to create the content, and organizing the content may include determining location data associated with each received content stream.

In some embodiments, the metadata may include user data associated with the user creating the content. Organizing the content may include determining a user type associated with each received content stream. For example, the user type may indicate that the user is a host of a private party room, a selected user selected in a private party room, a non-selected user, and/or the like. The user type may be used in determining a layout associated with a content stream. For example, with reference to FIG. 5, content associated with a host and/or a selected user may be positioned in a main screen, while content associated with other (e.g., non-selected) users may be positioned in a smaller screen.

The content organization module 106 may be embodied on (e.g., operate on, stored on) a server computer, such as a centralized server, a cloud-based server, or any other server computer.

D. Content Display Module

A content display module 108 may include hardware and/or software configured to display content on a user device. For example, the content display module 108 may interface with a display screen connected to a user device to display the content on the display screen. In embodiments, the content display module 108 may receive streaming content from a server computer for display at the user device. The content display module 108 may be configured to cause a user device to display the content in a defined layout. For example, the layout may be defined by the content organization module 106. In some embodiments, the content display module 108 may receive a plurality of content streams for display in the layout. Alternatively, the content display module may receive a single stream comprising the plurality of content items, aggregated and laid out based on the determined layout.

In embodiments, the content display module 108 may be embodied on (e.g., operate on, stored on, or interfaced with) a user device, such as a laptop or desktop computer, a tablet computer, a smartphone, or other smart device, and/or any other computing device operated by a platform user.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 800 may be employed in the performance of some or all of the stages disclosed with regard to the methods. Similarly, an apparatus may be employed in the performance of some or all of the stages of the methods. As such, the apparatus may comprise at least those architectural components as found in computing device 800.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Method of Operation

Consistent with embodiments of the present disclosure, a method may be performed by at least one of the aforementioned modules. The method may be embodied as, for example, but not limited to, computer instructions, which when executed, perform the method.

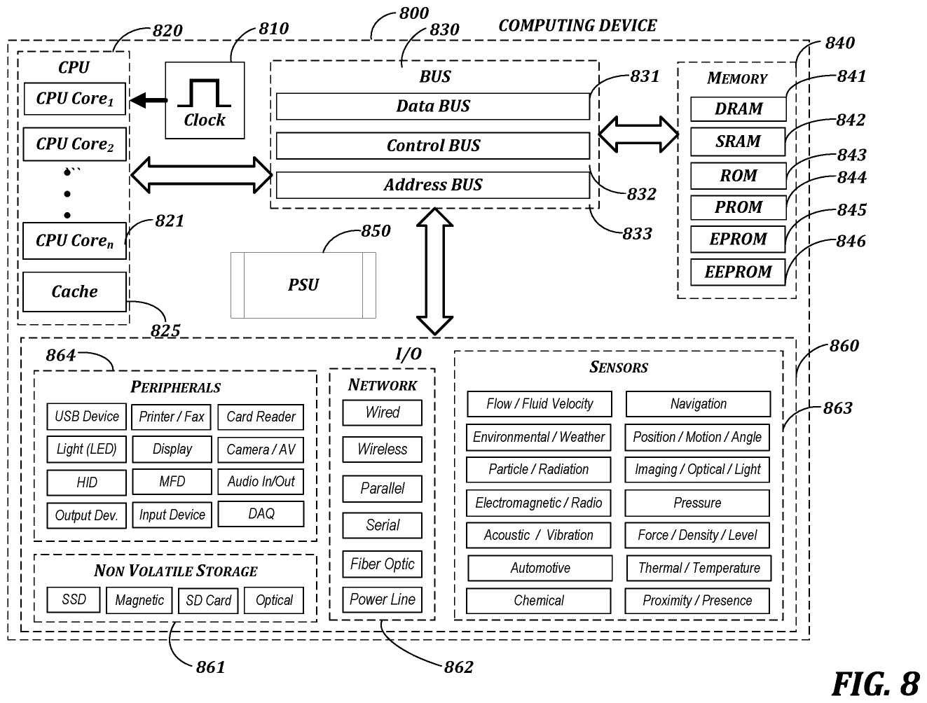

FIG. 6 is a flow chart setting forth the general stages involved in a method 600 consistent with an embodiment of the disclosure for providing the entity classification and data risk assessment platform 100. Method 600 may be implemented using a computing device 800 or any other component associated with platform 100 as described in more detail below with respect to FIG. 8. For illustrative purposes alone, computing device 800 is described as one potential actor in the follow stages.

Method 600 may begin at starting block 605 and proceed to stage 610, where computing device 800 may receive login information associated with a particular user. In embodiments, the particular user may transmit, to the computing device, login information including, for example a username, password, and/or other credentials for identity verification. The computing device may verify the received credentials from the user.

After verifying user credentials in stage 610, the user may transmit, to the platform, content generated at the user device in stage 620. In embodiments, the content may include, for example video and/or audio content generated by the user. As a particular example, the content may comprise a live video feed captured by a camera controlled by the user. In some embodiments, the content may include messaging content, such as text-based content, emojis, and/or the like.

In embodiments, the content may further comprise metadata. The metadata may include various information associated with the content. For example, the metadata may include a geolocation associated with the content (e.g., a location of the device capturing the content and/or the device transmitting the content to the computing device). The metadata may include user information, including user identification information, user demographic information, user type information, and/or the like. The metadata may include platform information, including an identifier of a room which the user has “entered” or become associated with.

Responsive to receiving the user-generated content in stage 620, the method may proceed to stage 630, where the computing device may organize the received content. In embodiments, organizing the content may comprise aggregating the user-generated content received from the user with content received from one or more additional users. For example, the computing device may aggregate the content from the user with content from other users in a similar geographic area (e.g., within a threshold distance of the user), other users in the same room of the platform, other users with similar user information, and/or the like. There are many ways that the content may be aggregated.

In some embodiments, organizing the content may comprise positioning content within a layout for display to a user. The position may be based, at least in part, on the received metadata. For example, position may be based on the user information, including the user type.

In some embodiments, the user generated content may be aggregated with advertising content. The advertising content may comprise one or more advertisements for display to the one or more users.

In some embodiments, organizing the content may include determining a position of the user content within a layout and marking the content with corresponding positioning information. Additionally or alternatively, organizing the content may comprise generating an organized content stream comprising the plurality of content items (e.g., the user-generated content, the advertisement content, any platform-based content, and/or the like) arranged in a particular layout for transmission as a single content stream.

After the content has been organized in stage 630, the method 600 may continue to stage 640, the computing device may transmit the organized content to one or more users for display. In embodiments, transmitting the content may comprise transmitting the content using one or more streaming protocols for real-time or near-real time display. The content may be transmitted to the one or more users based on the metadata received from the users. For example, the content may be transmitted to one or more users in a particular geographic location, one or more users having matching or substantially matching user information, one or more users having matching platform information (e.g., one or more users that are members of the same room), and/or the like.

In some embodiments, transmitting the content may include transmitting a plurality of content streams corresponding to a plurality of content items included within a layout. Alternatively, transmitting the content may include transmitting the single organized content stream generated in stage 630. In embodiments, each user device receiving the content may cause display of the received content on a display device.

Following transmission of the content in stage 640, the method 600 may in in stage 650.

### Example Embodiment 1

Consistent with embodiments of the present disclosure, a method may be performed by at least one of the aforementioned modules. The method may be embodied as, for example, but not limited to, computer instructions, which when executed, perform the method. The method may comprise the following stages:

A user opens the application and logs in to the platform. Upon logging in, the user may select Washington DC as a current location. A map of the location (e.g., Washington DC) may be displayed on the user's screen.

The user may view how many other users are in that location (e.g., within the same city and/or within a threshold distance of the selected location) In embodiments, the user may view how many users are active and online at the present time in the area, how many cameras are open to the public at the present time in the area, and/or other information associated with the geographic area.

The user may view and/or archive content (e.g., video and/or audio footage, photos, and/or the like) of current community members that are open to the public.

The user may view profiles of other users that are streaming live (if open to the public) in that location.

The user may “go live” by entering an existing room or starting a room. Once a user enters the room, the user may begin generating content associated with

Once in a room, the user may view content generated by other members of the room.

While this disclosure includes specific examples, it will be apparent after an understanding of the disclosure of this application has been attained that various changes in form and details may be made in these examples without departing from the spirit and scope of the claims and their equivalents.

### Example Embodiment 2

Consistent with embodiments of the present disclosure, a method may be performed by at least one of the aforementioned modules. The method may be embodied as, for example, but not limited to, computer instructions, which when executed, perform the method. The method may comprise the following stages:

In the disclosed platform, upon logging in, a digitized view of the globe may appear on a user's screen (e.g., computer or mobile device).

The user may be greeted verbally (e.g., virtually) and/or may be shown how many of the user's friends are currently online and active.

The application may also show how many cameras (e.g., video cams) are open to the public and/or how many cameras are in a surrounding community in total.

In embodiments, viewing features may vary depending on a user's device. Users may have access to any parts of the globe in which the user chooses.

Viewing features may be accessed through touch, talk, and/or text.

While this disclosure includes specific examples, it will be apparent after an understanding of the disclosure of this application has been attained that various changes in form and details may be made in these examples without departing from the spirit and scope of the claims and their equivalents.

B. Method of User Promotion

Consistent with embodiments of the present disclosure, a method may be performed by at least one of the aforementioned modules. The method may be embodied as, for example, but not limited to, computer instructions, which when executed, perform the method.

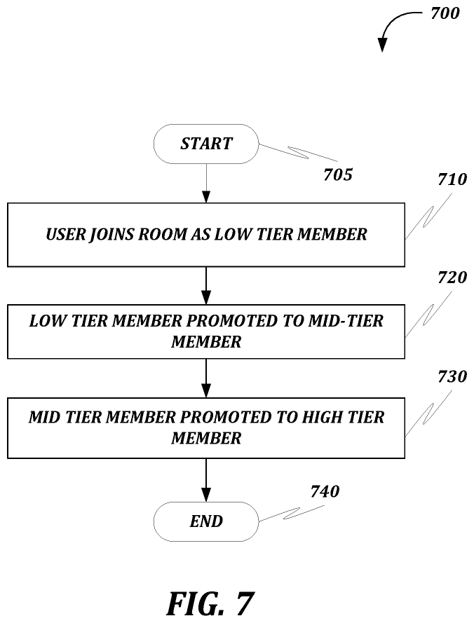

FIG. 7 is a flow chart setting forth the general stages involved in a method 700 consistent with an embodiment of the disclosure for providing the entity classification and data risk assessment platform 100. Method 700 may be implemented using a computing device 800 or any other component associated with platform 100 as described in more detail below with respect to FIG. 8. For illustrative purposes alone, computing device 800 is described as one potential actor in the follow stages.

Method 700 may begin at starting block 705 and proceed to stage 710, where a user may join a room. In some embodiments, joining a room may include receiving an invitation to join a room. The invitation may be received from any one of a subset of user members of the room and/or any users assigned to a control room associated with the room. In some embodiments, the subset includes all members of the room. In other embodiments, the subset may include fewer than all members of the room, for example, the room may be set up such that only the host is permitted to invite users into a room, or such that room members having a particular rank are permitted to invite users to join a room. In embodiments, a user may join a room as a low tier user (e.g., a tier 3 user).

A low tier user may have fewer options or privileges within a room. For example, a low tier user may not be permitted to stream content to the room, or may have a smaller screen on which content associated with the low tier user may be displayed. That is the low tier user may only be able to view content from the higher tier users and communicate with the room via a text chat.

In stage 720, a low tier user may receive a promotion to a mid-tier user (e.g., a tier 2 user). The promotion may be received from any one of a subset of user members of the room and/or any users assigned to the control room associated with the room. In some embodiments, the subset includes all members of the room having a higher rank that the low tier user. In other embodiments, the subset may include, for example, only the host, or the host and the one or more users assigned to the control room associated with the room.

In embodiments, a mid-tier user may have relatively more permissions and/or options in a room, relative to a low tier user. As a particular example, a mid-tier user may be permitted to stream content for viewing by the room, and/or may be assigned a more prominent location in a layout of a room. In some embodiments, the mid-tier user may be permitted to invite users to join the room, and/or to promote low tier members of the room to mid-tier members.

In stage 730, a mid-tier user may receive a promotion to a high tier user (e.g., a tier 1 user). The promotion may be received from any one of a subset of user members of the room and/or any users assigned to the control room associated with the room. In some embodiments, the subset includes all members of the room having a higher rank that the mid-tier user. In other embodiments, the subset may include, for example, only the host, or the host and the one or more users assigned to the control room associated with the room.

In embodiments, a high tier user may have relatively more permissions and/or options in a room, relative to a low tier user or a mid-tier user. As a particular example, a high tier user may be permitted to stream content for viewing by the room, and/or may be assigned a more prominent location in a layout of a room, relative to a mid-tier user. In some embodiments, the high tier user may be permitted to invite users to join the room, and/or to promote low tier members of the room to mid-tier members, and/or to promote mid-tier members of the room to high tier members.

The method 700 may then end at stage 740.

### V. Computing Device Architecture

Embodiments of the present disclosure provide a hardware and software platform operative as a distributed system of modules and computing elements.

Platform 100 may be embodied as, for example, but not be limited to, a website, a web application, a desktop application, backend application, and a mobile application compatible with a computing device 800. The computing device 800 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

Platform 100 may be hosted on a centralized server or a cloud computing service. Although method 600 has been described to be performed by a computing device 800, it should be understood that, in some embodiments, different operations may be performed by a plurality of the computing devices 800 in operative communication at least one network.

Embodiments of the present disclosure may comprise a system having a central processing unit (CPU) 820, a bus 830, a memory unit 840, a power supply unit (PSU) 850, and one or more Input/Output (I/O) units. The CPU 820 coupled to the memory unit 840 and the plurality of I/O units 860 via the bus 830, all of which are powered by the PSU 850. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 8 is a block diagram of a system including computing device 800. Consistent with an embodiment of the disclosure, the aforementioned CPU 820, the bus 830, the memory unit 840, a PSU 850, and the plurality of I/O units 860 may be implemented in a computing device, such as computing device 800 of FIG. 8. Any suitable combination of hardware, software, or firmware may be used to implement the aforementioned units. For example, the CPU 820, the bus 830, and the memory unit 840 may be implemented with computing device 800 or any of other computing devices 800, in combination with computing device 800. The aforementioned system, device, and components are examples and other systems, devices, and components may comprise the aforementioned CPU 820, the bus 830, the memory unit 840, consistent with embodiments of the disclosure.

At least one computing device 800 may be embodied as any of the computing elements illustrated in all of the attached figures. A computing device 800 does not need to be electronic, nor even have a CPU 820, nor bus 830, nor memory unit 840. The definition of the computing device 800 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 800, especially if the processing is purposeful.

With reference to FIG. 8, a system consistent with an embodiment of the disclosure may include a computing device, such as computing device 800. In a basic configuration, computing device 800 may include at least one clock module 810, at least one CPU 820, at least one bus 830, and at least one memory unit 840, at least one P SU 850, and at least one I/O 860 module, wherein I/O module may be comprised of, but not limited to a non-volatile storage sub-module 861, a communication sub-module 862, a sensors sub-module 863, and a peripherals sub-module 864.

A system consistent with an embodiment of the disclosure the computing device 800 may include the clock module 810 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 820, the central component of modern computers, which relies on a clock. The only exceptions are asynchronous circuits such as asynchronous CPUs. The clock 810 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 800 use a “clock multiplier” which multiplies a lower frequency external clock to the appropriate clock rate of the CPU 820. This allows the CPU 820 to operate at a much higher frequency than the rest of the computer, which affords performance gains in situations where the CPU 820 does not need to wait on an external factor (like memory 840 or input/output 860). Some embodiments of the clock 810 may include dynamic frequency change, where, the time between clock edges can vary widely from one edge to the next and back again.

A system consistent with an embodiment of the disclosure the computing device 800 may include the CPU unit 820 comprising at least one CPU Core 821. A plurality of CPU cores 821 may comprise identical CPU cores 821, such as, but not limited to, homogeneous multi-core systems. It is also possible for the plurality of CPU cores 821 to comprise different CPU cores 821, such as, but not limited to, heterogeneous multi-core systems, big.LITTLE systems and some AMD accelerated processing units (APU). The CPU unit 820 reads and executes program instructions which may be used across many application domains, for example, but not limited to, general purpose computing, embedded computing, network computing, digital signal processing (DSP), and graphics processing (GPU). The CPU unit 820 may run multiple instructions on separate CPU cores 821 at the same time. The CPU unit 820 may be integrated into at least one of a single integrated circuit die and multiple dies in a single chip package. The single integrated circuit die and multiple dies in a single chip package may contain a plurality of other aspects of the computing device 800, for example, but not limited to, the clock 810, the CPU 820, the bus 830, the memory 840, and I/O 860.

The CPU unit 820 may contain cache 822 such as, but not limited to, a level 1 cache, level 2 cache, level 3 cache or combination thereof. The aforementioned cache 822 may or may not be shared amongst a plurality of CPU cores 821. The cache 822 sharing comprises at least one of message passing and inter-core communication methods may be used for the at least one CPU Core 821 to communicate with the cache 822. The inter-core communication methods may comprise, but not limited to, bus, ring, two-dimensional mesh, and crossbar. The aforementioned CPU unit 820 may employ symmetric multiprocessing (SMP) design.

The plurality of the aforementioned CPU cores 821 may comprise soft microprocessor cores on a single field programmable gate array (FPGA), such as semiconductor intellectual property cores (IP Core). The plurality of CPU cores 821 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 821, for example, but not limited to Instruction-level parallelism (ILP) such as, but not limited to, superscalar pipelining, and Thread-level parallelism (TLP).

Consistent with the embodiments of the present disclosure, the aforementioned computing device 800 may employ a communication system that transfers data between components inside the aforementioned computing device 800, and/or the plurality of computing devices 800. The aforementioned communication system will be known to a person having ordinary skill in the art as a bus 830. The bus 830 may embody internal and/or external plurality of hardware and software components, for example, but not limited to a wire, optical fiber, communication protocols, and any physical arrangement that provides the same logical function as a parallel electrical bus. The bus 830 may comprise at least one of, but not limited to a parallel bus, wherein the parallel bus carry data words in parallel on multiple wires, and a serial bus, wherein the serial bus carry data in bit-serial form. The bus 830 may embody a plurality of topologies, for example, but not limited to, a multidrop/electrical parallel topology, a daisy chain topology, and a connected by switched hubs, such as USB bus. The bus 830 may comprise a plurality of embodiments, for example, but not limited to:
Internal data bus (data bus) 831/Memory bus
Control bus 832
Address bus 833
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 800 may employ hardware integrated circuits that store information for immediate use in the computing device 800, know to the person having ordinary skill in the art as primary storage or memory 840. The memory 840 operates at high speed, distinguishing it from the non-volatile storage sub-module 861, which may be referred to as secondary or tertiary storage, which provides slow-to-access information but offers higher capacities at lower cost. The contents contained in memory 840, may be transferred to secondary storage via techniques such as, but not limited to, virtual memory and swap. The memory 840 may be associated with addressable semiconductor memory, such as integrated circuits consisting of silicon-based transistors, used for example as primary storage but also other purposes in the computing device 800. The memory 840 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 841, Static Random-Access Memory (SRAM) 842, CPU Cache memory 825, Advanced Random-Access Memory (A-RAM), and other types of primary storage such as Random-Access Memory (RAM).
Non-volatile memory which can retain stored information even after power is removed, for example, but not limited to, Read-Only Memory (ROM) 843, Programmable ROM (PROM) 844, Erasable PROM (EPROM) 845, Electrically Erasable PROM (EEPROM) 846 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 800 may employ the communication system between an information processing system, such as the computing device 800, and the outside world, for example, but not limited to, human, environment, and another computing device 800. The aforementioned communication system will be known to a person having ordinary skill in the art as I/O 860. The I/O module 860 regulates a plurality of inputs and outputs with regard to the computing device 800, wherein the inputs are a plurality of signals and data received by the computing device 800, and the outputs are the plurality of signals and data sent from the computing device 800. The I/O module 860 interfaces a plurality of hardware, such as, but not limited to, non-volatile storage 861, communication devices 862, sensors 863, and peripherals 864. The plurality of hardware is used by the at least one of, but not limited to, human, environment, and another computing device 800 to communicate with the present computing device 800. The I/O module 860 may comprise a plurality of forms, for example, but not limited to channel I/O, port mapped I/O, asynchronous I/O, and Direct Memory Access (DMA).

Consistent with the embodiments of the present disclosure, the aforementioned computing device 800 may employ the non-volatile storage sub-module 861, which may be referred to by a person having ordinary skill in the art as one of secondary storage, external memory, tertiary storage, off-line storage, and auxiliary storage. The non-volatile storage sub-module 861 may not be accessed directly by the CPU 820 without using intermediate area in the memory 840. The non-volatile storage sub-module 861 does not lose data when power is removed and may be two orders of magnitude less costly than storage used in memory module, at the expense of speed and latency. The non-volatile storage sub-module 861 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (861) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD−R/DVD+R/DVD−RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 800 may employ the communication sub-module 862 as a subset of the I/O 860, which may be referred to by a person having ordinary skill in the art as at least one of, but not limited to, computer network, data network, and network. The network allows computing devices 800 to exchange data using connections, which may be known to a person having ordinary skill in the art as data links, between network nodes. The nodes comprise network computer devices 800 that originate, route, and terminate data. The nodes are identified by network addresses and can include a plurality of hosts consistent with the embodiments of a computing device 800. The aforementioned embodiments include, but not limited to personal computers, phones, servers, drones, and networking devices such as, but not limited to, hubs, switches, routers, modems, and firewalls.

Two nodes can be said are networked together, when one computing device 800 is able to exchange information with the other computing device 800, whether or not they have a direct connection with each other. The communication sub-module 862 supports a plurality of applications and services, such as, but not limited to World Wide Web (WWW), digital video and audio, shared use of application and storage computing devices 800, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 862 may comprise a plurality of size, topology, traffic control mechanism and organizational intent. The communication sub-module 862 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 800 may employ the sensors sub-module 863 as a subset of the I/O 860. The sensors sub-module 863 comprises at least one of the devices, modules, and subsystems whose purpose is to detect events or changes in its environment and send the information to the computing device 800. Sensors are sensitive to the measured property, are not sensitive to any property not measured, but may be encountered in its application, and do not significantly influence the measured property. The sensors sub-module 863 may comprise a plurality of digital devices and analog devices, wherein if an analog device is used, an Analog to Digital (A-to-D) converter must be employed to interface the said device with the computing device 800. The sensors may be subject to a plurality of deviations that limit sensor accuracy. The sensors sub-module 863 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 800 may employ the peripherals sub-module 862 as a subset of the I/O 860. The peripheral sub-module 864 comprises ancillary devices uses to put information into and get information out of the computing device 800. There are 3 categories of devices comprising the peripheral sub-module 864, which exist based on their relationship with the computing device 800, input devices, output devices, and input/output devices. Input devices send at least one of data and instructions to the computing device 800. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 800. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 864:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 800. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 800 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 800. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC).
Input/Output Devices may further comprise, but not be limited to, touchscreens, networking device (e.g., devices disclosed in network 862 sub-module), data storage device (non-volatile storage 861), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### IV. Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. View VIP users

Non VIP users can see users

VIP room

They have their own discussions (their own room to discuss).

### Aspect 2. Token Based Currency

One of the following options:

Blockchain based

Create their own currency
Their own “paypal”.

### Aspect 3. 360 View Experience

Capture visual experience from all angles

360 studio/camera setup that can bring in live performers & control the visual experience for the user better

Set up camera posts/aggregate livestreams from actual live concerts

Filters of different virtual environments that will go around the performer.

### Aspect 4. Manager Feature

Making a digital twin where the other can control the page while the other artist
EX: Notification sent to artist→manager engages on behalf of the artist.

### Aspect 5. Covid Screening

Vaccination selection (Yes, no, prefer not to answer)
Provide an optional profile badge/privilege to those who choose yes
   Allow only into certain rooms, groups, etc.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application.

1. One or more non-transitory computer readable media comprising instructions which, when executed by one or more hardware processors, causes performance of operations comprising:
authenticating a user;
receiving content from the authenticated users;
receiving metadata associated with the content;
organizing the content based on the received metadata; and
transmitting an organized content feed to one or more users for display.

2. The non-transitory computer-readable media of claim 1, wherein organizing the content comprises selecting a layout position for the content, from among a plurality of potential layout positions in the organized content feed.

3. The non-transitory computer-readable media of claim 2, wherein organizing the content comprises:
receiving second content from a second user; and
aggregating the content with the second content into the organized content feed.

4. The non-transitory computer-readable media of claim 2, wherein organizing the content comprises:
receiving advertising content; and
aggregating the content with the advertising content into the organized content feed.

2. non-transitory computer readable media of claim 2, wherein the metadata comprises a user type, and wherein organizing the content comprises selecting the layout position based on the user type.

6. The non-transitory computer-readable media of claim 1, wherein the user is associated with a particular room, and wherein transmitting the organized content feed to the one or more other users comprises transmitting the content to one or more other users associated with the same room.

7. The non-transitory computer-readable media of claim 1, wherein the content comprises video content captured by a user device associated with the authenticated user.

8. A method comprising:
authenticating a user;
receiving content from the authenticated users;
receiving metadata associated with the content;
organizing the content based on the received metadata; and
transmitting an organized content feed to one or more users for display,
wherein the method is performed by at least one device including a hardware processor.

9. The method of claim 8, wherein organizing the content comprises selecting a layout position for the content, from among a plurality of potential layout positions in the organized content feed.

10. The method of claim 9, wherein organizing the content comprises:
receiving second content from a second user; and
aggregating the content with the second content into the organized content feed.

11. The method of claim 9, wherein organizing the content comprises:
receiving advertising content; and
aggregating the content with the advertising content into the organized content feed.

12. The method of claim 9, wherein the metadata comprises a user type, and wherein organizing the content comprises selecting the layout position based on the user type.

13. The method of claim 8, wherein the user is associated with a particular room, and wherein transmitting the organized content feed to the one or more other users comprises transmitting the content to one or more other users associated with the same room.

14. The method of claim 8, wherein the content comprises video content captured by a user device associated with the authenticated user.

15. A system comprising:
at least one device including a hardware processor;
the system being configured to perform operations comprising:
authenticating a user;
receiving content from the authenticated users;
receiving metadata associated with the content;
organizing the content based on the received metadata; and
transmitting an organized content feed to one or more users for display.

16. The system of claim 15, wherein organizing the content comprises selecting a layout position for the content, from among a plurality of potential layout positions in the organized content feed.

17. The system of claim 16, wherein organizing the content comprises:
receiving second content from a second user; and
aggregating the content with the second content into the organized content feed.

18. The system of claim 16, wherein organizing the content comprises:
receiving advertising content; and
aggregating the content with the advertising content into the organized content feed.

19. The system of claim 16, wherein the metadata comprises a user type, and wherein organizing the content comprises selecting the layout position based on the user type.

20. The system of claim 15, wherein the user is associated with a particular room, and wherein transmitting the organized content feed to the one or more other users comprises transmitting the content to one or more other users associated with the same room.
